(19) United States
(12) Patent Application Publication
(10) Pub. No.: US 2010/0048042 A1
(43) Pub. Date: Feb. 25, 2010

(54) ESATA SOCKET INTEGRATED WITH DC PINS

(76) Inventor: Jui-Tu CHIANG, Jhonghe City (TW)

Correspondence Address: Hershkovitz & Associates, LLC, 2845 Duke Street, Alexandria, VA, 22314, US

(21) Appl. No.: 12/254,461

(22) Filed: Oct. 20, 2008

(30) Foreign Application Priority Data
Aug. 19, 2008 (TW) 097214833

(51) Int. Cl. H01R 12/00

(52) U.S. Cl. 439/76.1

(57) ABSTRACT

An external serial advanced technology attachment (eSATA) socket integrated with DC pins has a body, an eSATA terminal set, a power terminal set and a metal housing. A front surface of the body is formed with a open groove, from which a connecting plate protrudes for the eSATA terminal set to be mounted on its first surface. The body is enclosed by the metal housing. Two opposite sidewalls of the open groove on the body are respectively provided with a power pin at a height corresponding to and parallel to the eSATA terminal set. The power pins are to be soldered to an external power. Therefore, after an eSATA connector that accommodates the eSATA socket is inserted, the power terminals transmit working power to the eSATA connector. This saves the wires and cost of the external power supply, making the eSATA socket convenient to use.

### BACKGROUND OF THE INVENTION

1. Field of the Invention

The invention relates to an eSATA socket and, in particular, to an eSATA socket integrated with DC pins.

2. Description of Related Art

To effectively transmit data between computers and computer peripherals, there are connectors using different communication protocol standards. In view of the trend that computer products become more compact, the connectors also become thinner. In particular, connectors of the serial transmission are most popular. These include the external serial advanced technology attachment (eSATA), universal serial bus (USB), etc.

Since the USB connector includes two DC terminals according to its protocol standard, computer peripherals that use the USB connector do not need extra external power. Therefore, the computer peripheral can obtain its working power after it is inserted into the USB connector of the computer. This is very convenient. Due to its original protocol standard, the eSATA connector requires an external power supply to function normally. However, the eSATA protocol standard is higher than the USB protocol standard. Thus, the eSATA connector is very popular in computers and computer peripherals. The design of an external power supply does not only increase the cost of the product using the eSATA connector, it is also difficult for the product to become compact. Therefore, it is necessary to further improve the eSATA connector.

### SUMMARY OF THE INVENTION

In view of the foregoing, an objective of the invention is to provide an eSATA socket that is integrated with internal power pins.

To achieve the above-mentioned objective, the disclosed eSATA socket includes: a body, an eSATA terminal set, a power terminal set, and a metal housing. The body has a front surface formed with an open groove inward. A connecting plate protrudes from the back wall of the open groove. The eSATA terminal set has seven horizontally disposed pins. The front electrical connection section of each pin is fixed on a first surface of the connecting plate on the body. The rear soldering section of each pin goes through the back wall of the open groove, protruding for soldering. The power terminal set has two power pins disposed on the two opposite sidewalls of the open groove. They are parallel to the seven pins of the eSATA terminal set. The back end of each power pin also penetrates through the back wall of the open groove for the soldering connection of an external power supply (DC power supply below 24 V). The metal housing covers the body, with the open groove and the rear soldering section of the eSATA terminal set being exposed.

The two sidewalls of the body open groove are disposed with a power terminal set. After an eSATA connector matching with this structure is inserted, the power terminal set directly provides the working power to the eSATA connector. In addition to saving the wires and cost for connecting to an external power supply, it is also very convenient in use.

Another objective of the invention is to provide an eSATA socket integrated with a USB terminal set. The terminals of the USB terminal set are disposed on a second surface of the chip. They include two terminals that provide 5 V DC power. When an eSATA connector matching with this structure is inserted, the eSATA connector can simultaneously use the 5 V DC power of the USB terminal set and the DC power smaller than 24 V provided by the two pins on both sides of the eSATA terminal set.

A further objective of the invention is to provide an eSATA socket integrated with two different USB protocol standards. The second surface of the connecting plate is provided with a terminal set of one USB protocol standard. Several pins of the seven eSATA pins are used as terminals of another USB protocol standard. When an eSATA connector matching with this structure is inserted, the eSATA connector can simultaneously enjoy the 5 V DC power provided by the USB terminal set on the second surface of the connecting plate and the 24 V DC power provided by the two pins on both sides of the eSATA terminal set.

### BRIEF DESCRIPTION OF THE DRAWINGS

FIG. 1 is an exploded perspective view according to a first embodiment of an eSATA socket of the present invention;

FIGS. 2A and 2B are perspective views of the first embodiment of FIG. 1;

FIG. 3 is a front view of the eSATA socket of FIG. 1;

FIG. 4 is a perspective view of the invention accommodating to an eSATA connector;

FIG. 5 is an exploded perspective view of FIG. 4;

FIG. 6 is a side cross-sectional view of the invention being connected to an eSATA connector;

FIG. 7 shows a longitudinal cross section of the invention being connected to an eSATA connector;

FIGS. 8A and 8B are exploded perspective views according to a second embodiment of an eSATA socket of the present invention;

FIGS. 9A and 9B are perspective views of the assembled eSATA socket of FIGS. 8A and 8B;

FIG. 10 is a front view of FIG. 8A;

FIG. 11 is an exploded bottom perspective view of the second embodiment of the eSATA socket and an eSATA connector;

FIG. 12 is an exploded perspective view of FIG. 11;

FIG. 13 is a side cross-sectional view of the second embodiment of the eSATA socket in accordance with the present invention to be connected to an eSATA connector;

FIG. 14 shows a partial longitudinal cross section of the second embodiment inserted with an eSATA connector;

FIGS. 15A and 15B are exploded perspective views of a third embodiment of the eSATA socket in accordance with the present invention;

FIG. 16 is a bottom perspective view of FIG. 15A;

FIG. 17 is a front view of FIG. 15A;

FIG. 18 is a perspective view of the third embodiment being connected to an eSATA connector;

FIGS. 19A and 19B are exploded perspective views of FIG. 18;

FIG. 20 is a side cross section view of the third embodiment and the separate eSATA connector; and

FIG. 21 is a partial longitudinal cross section view of the third embodiment connected to an eSATA connector.

### DETAILED DESCRIPTION OF THE PREFERRED EMBODIMENT

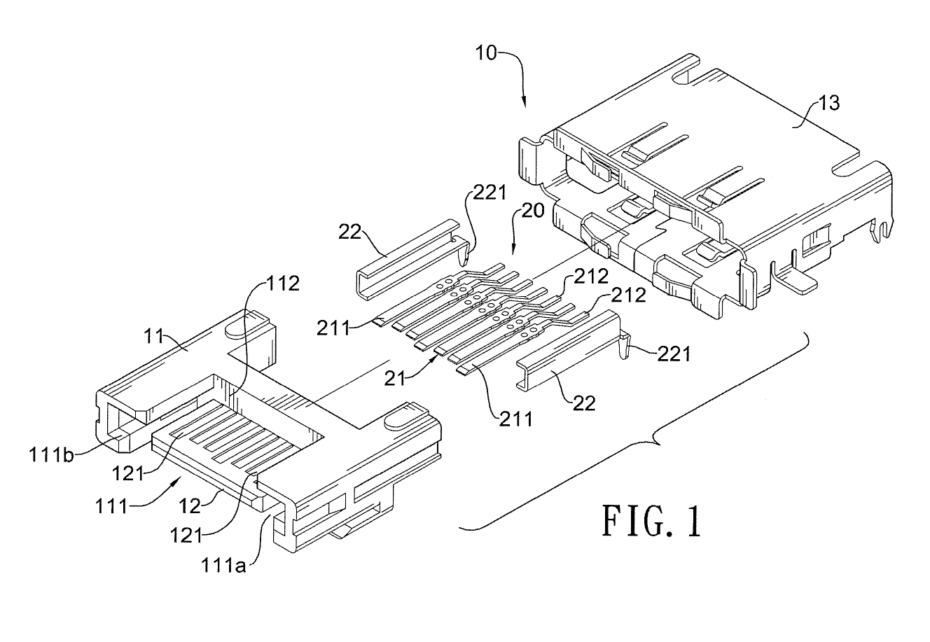

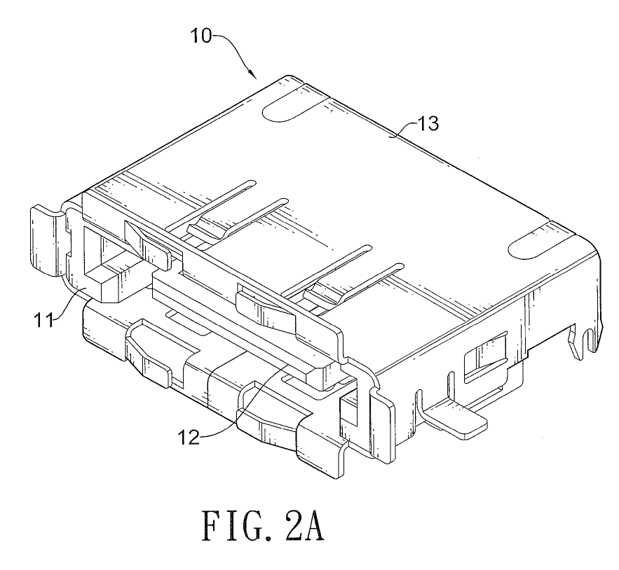

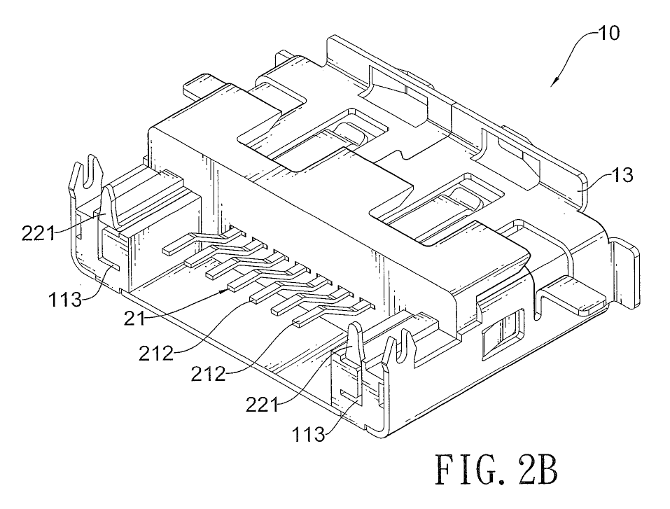

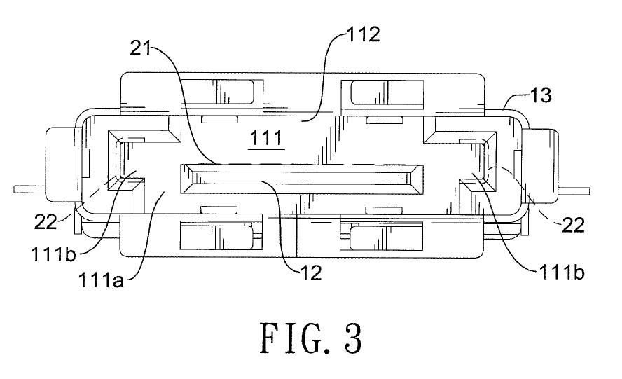

With reference to FIGS. 1, 2A, 2B, and 3, a first embodiment of an external serial advanced technology attachment (eSATA) socket 10 in accordance with the present invention comprises a body 11, an eSATA terminal set 20, a power terminal set and a metal housing 13.

The body 11 has a front surface formed with an open groove 111 inward. A connecting plate 12 protrudes from a back wall 112 of the open groove 111. A first surface of the connecting plate 12 is formed downward with seven parallel positioning grooves 121. In this embodiment, corresponding to the first surface of the connecting plate 12, two sliding grooves 113 are respectively formed from back to front on both sides of the body 11 and communicate with the open groove 111. The cross section of each of the sliding grooves 113 has a U shape.

The eSATA terminal set 20 has seven horizontally disposed pins 21. Each pin 21 has a front electrical connection section 211 and a rear soldering section 212. The front electrical connection section 211 of each pin 21 is mounted in the positioning groove 113 on the first surface of the connecting plate 12. The rear soldering section 212 penetrates through the back wall 112 of the open groove 111, protruding outward for a soldering connection.

The power terminal set includes two power pins 22, mounted respectively in the two opposite sidewalls of the open groove 111 and parallel to the seven pins 21 of the eSATA terminal set 20. The rear end of each power pin 22 also penetrates the back wall 112 of the open groove 111 for soldering with an external power supply (DC power supply under 24 V). Since the eSATA protocol uses a DC voltage below 24 V being higher than the voltage and currents transmitted by the seven pins 21, the volume of each power pin 22 is larger than that of each pin 21 of the eSATA terminal set 20 in order to convey stronger power. In this embodiment, the cross section of each power pin 22 has a U shape. A rear end of each power pin 22 is formed downward as a soldering section 221. Consequently, the two power pins 22 are inserted from back to front in the sliding grooves 113, in connection with the body 11.

The metal housing 13 covers the body 11. The open groove 111 and the rear soldering section 212 of each pin 21 in the eSATA terminal set 20 are exposed.

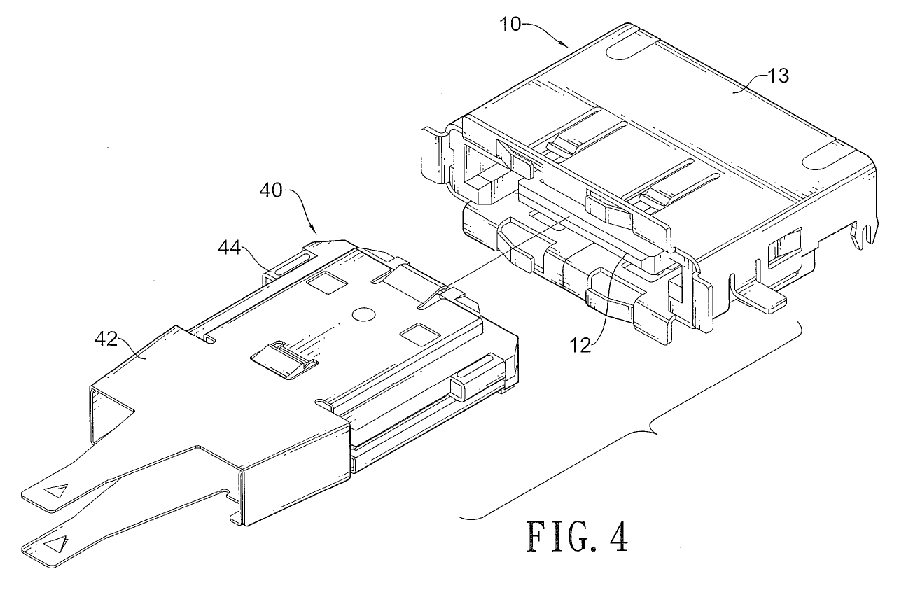

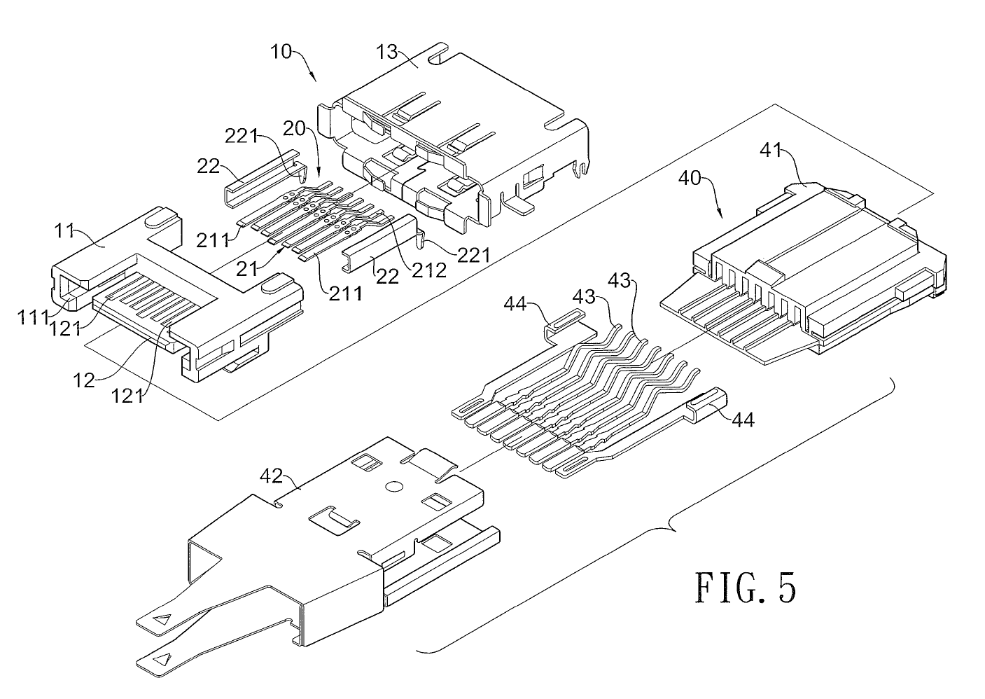

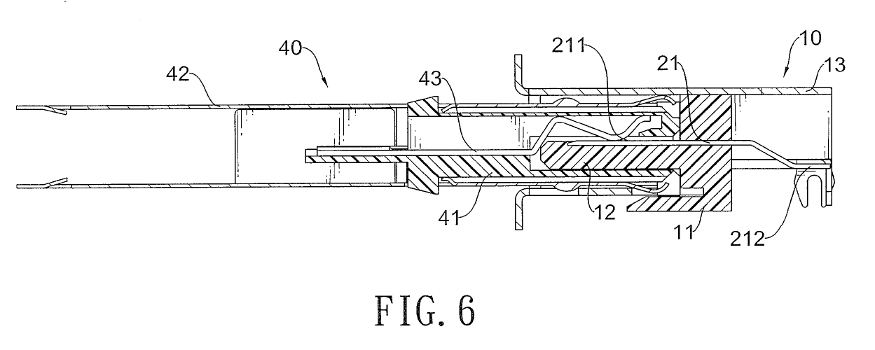

With reference to FIGS. 4 to 6, the first embodiment of the eSATA socket in accordance with the invention is to be connected to an eSATA connector 40. The connector 40 has seven parallel eSATA signal terminals 43 in its base 41. The front electrical connection section of each eSATA signal terminal 43 is bent and flexible. The rear end of each eSATA signal terminal goes through the back side of the base 41 and protrudes for soldering. The base 41 is enclosed by a metal housing 42. Each of the two opposite sidewalls of the base 41 is formed with a power terminal 44 whose cross section has a U shape. The volume of each power terminal 44 is larger than the eSATA signal terminal 43.

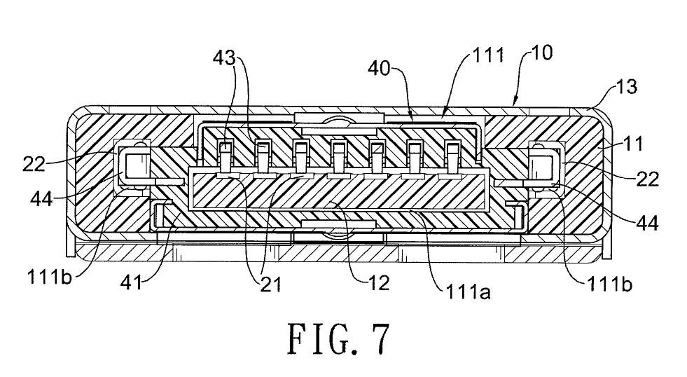

When this connector 40 is inserted into the socket 10, the front electrical connection sections of the seven internal eSATA signal terminals 43 go upward because they enter the connecting plate 12, and contact the seven pins 21 of the connecting plate 12. Since the power terminals 44 are disposed on the two opposite sidewalls of the base 41, they are in touch with the power pins 22 on the two sidewalls of the open groove 111 of the socket 10, as shown in FIG. 7. The power terminals 44 thus conveniently obtain the working power.

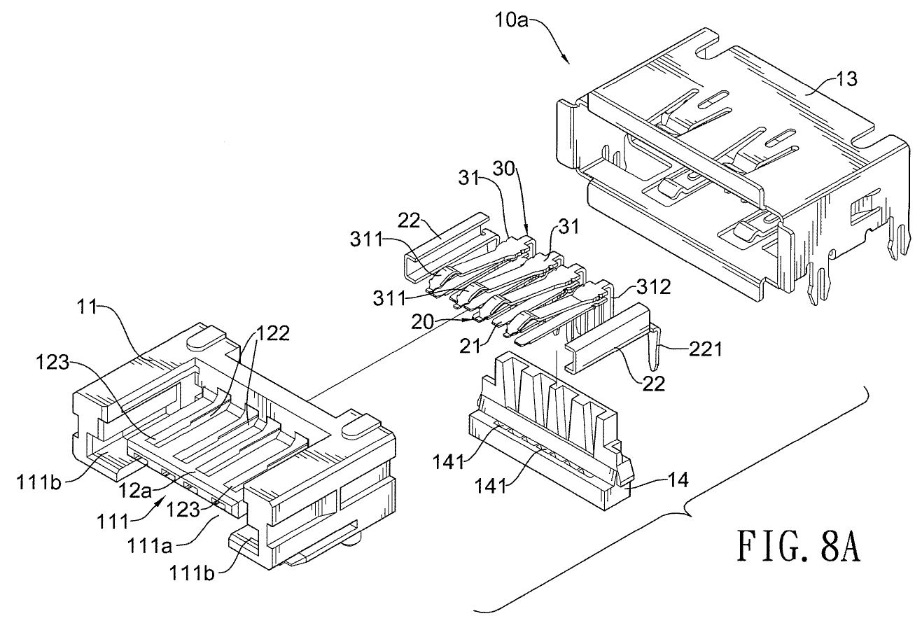

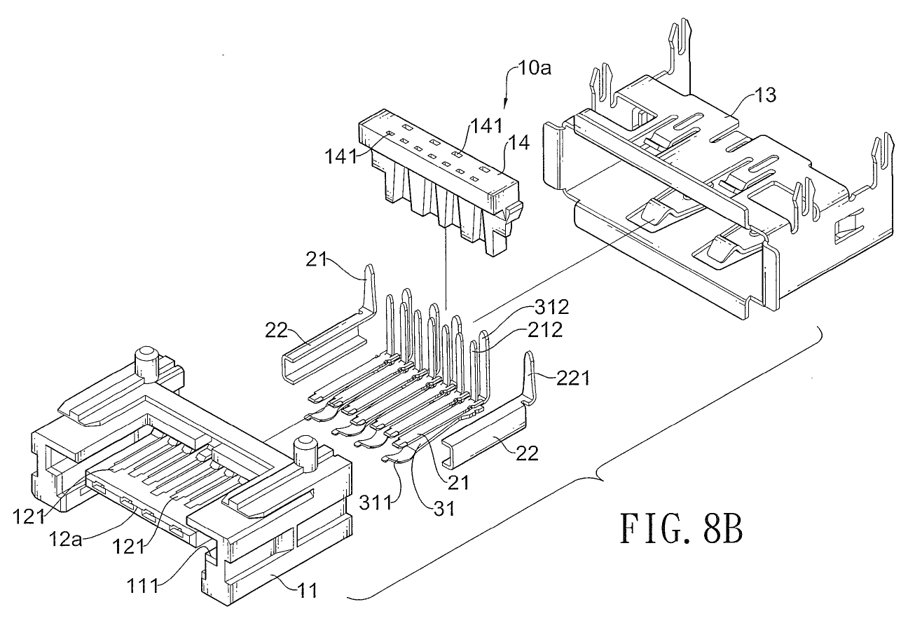

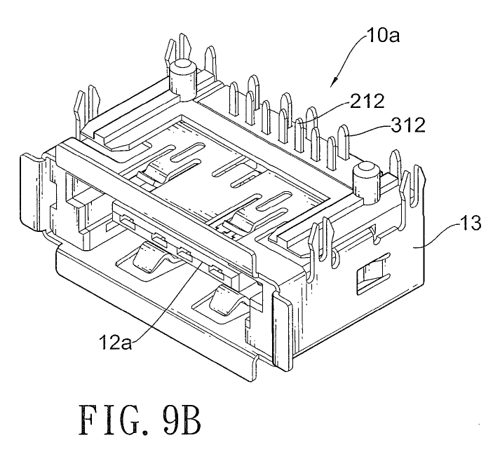

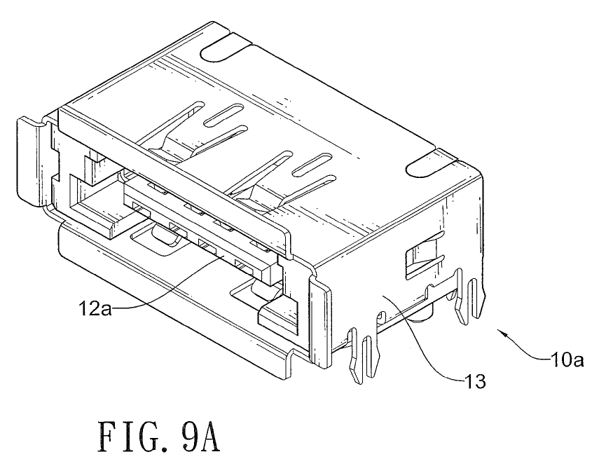

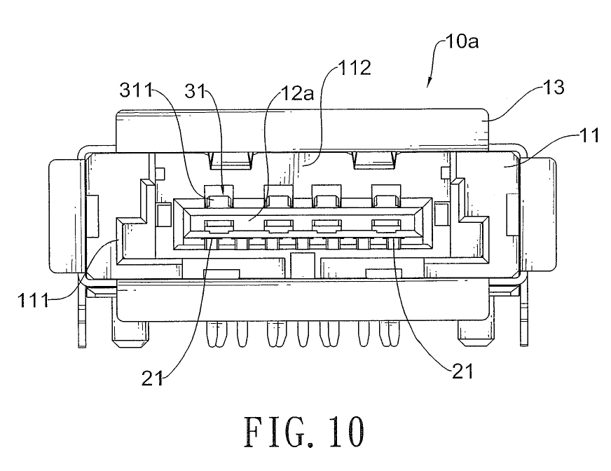

With reference to FIGS. 8A, 8B, 9A, 9B, and 10, a second embodiment of the socket 10a is basically the same as the first embodiment. However, the socket 10a is further integrated with a USB terminal set, forming a two-in-one electrical connector. The seven positioning grooves 121 of the connecting plate 12a in this embodiment are formed on the second surface of the connecting plate 12, for mounting the seven pins 21 of the eSATA terminal set 20. The power terminals 22 are also disposed on the two opposite sidewalls of the open groove 11 land disposed at the height corresponding to the eSATA terminal set 20 on the second surface of the connecting plate 12b.

The connecting plate 12a in the second embodiment is further formed with four parallel channels 122 penetrating from back to front. A front surface of the connecting plate 12a is formed with four openings corresponding to the for channels 122 respectively. The first surface of the connecting plate 12a is formed with four parallel long grooves 123.

Moreover, a USB terminal set 30 includes four USB terminals 31 is mounted in the body 11. The front connection section of each USB terminal 31 is mounted in the corresponding long groove 123. Besides, the front connection section of each USB terminal 31 is formed with an upward bending portion 311. The upward bending portion 311 is depressed downward and extends forward when a pressure is applied to on the upward bending portion 311. Therefore, the front ends of the channels 122 provide the space for all the deformed terminals 31 to extend forward. The rear soldering section 312 of each terminal 31 of the USB terminal set 30 penetrates through the back wall 112 of the groove 112 and bends downwards. The rear soldering section 212 of each pin 21 of the eSATA terminal set 20 also bends downwards. To fix the pins 21 of the eSATA terminal set 20 and the rear soldering section 312 of the terminal 31 in the USB terminal set, this embodiment includes a terminal base 14 formed with eleven longitudinal grooves 141. When the terminal base 14 is assembled to the rear side of the body 11 from bottom upwards, the eleven downward bending rear soldering sections 212, 312 go through the corresponding longitudinal grooves 141 and expose themselves downwards.

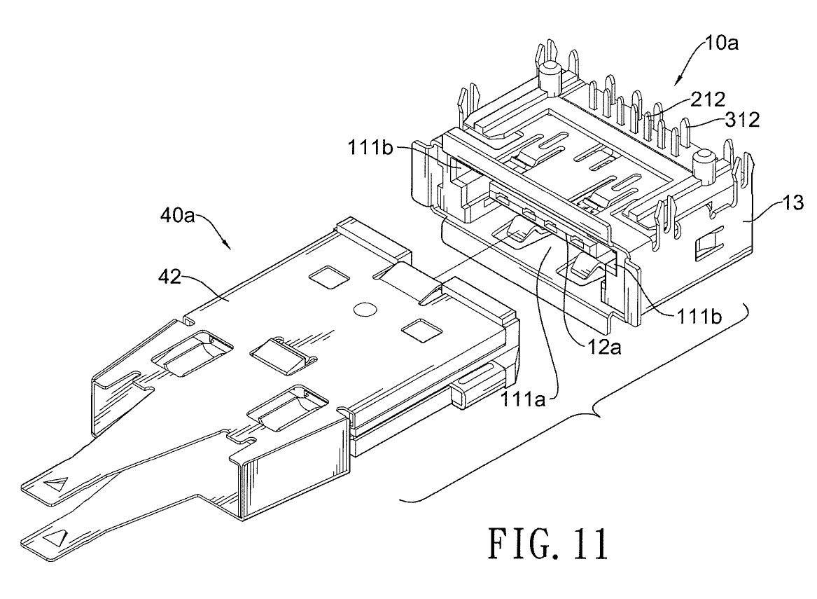

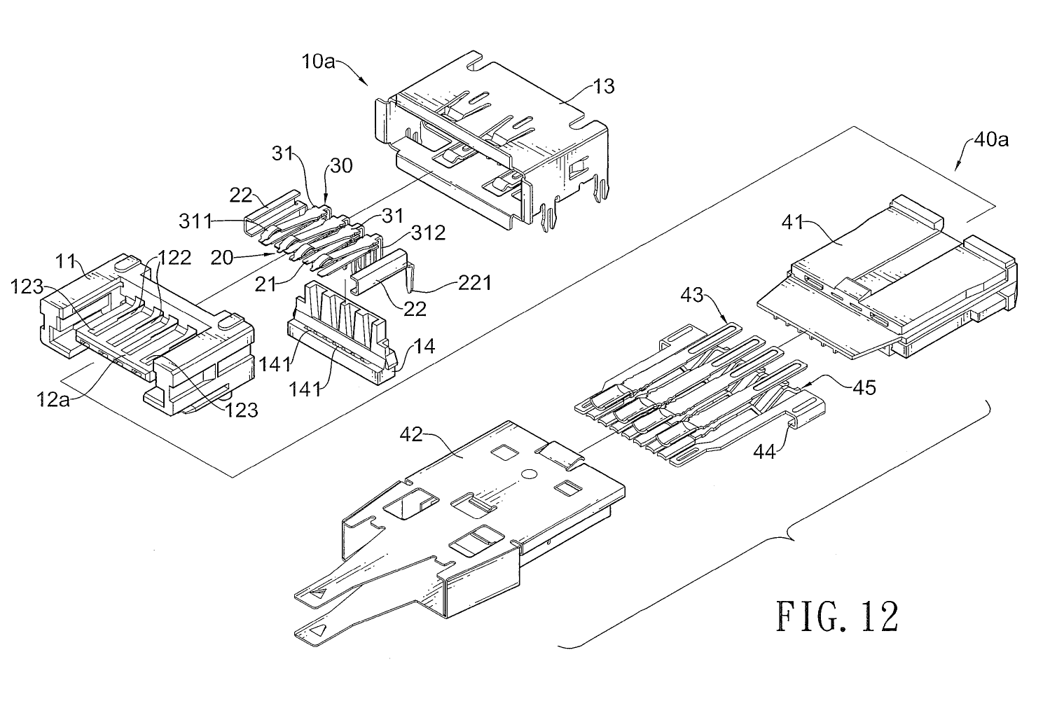

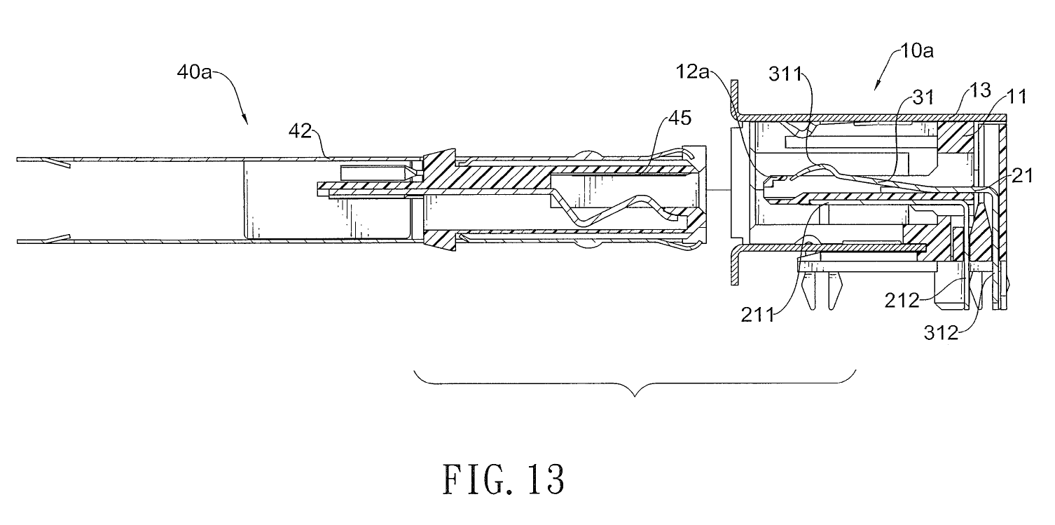

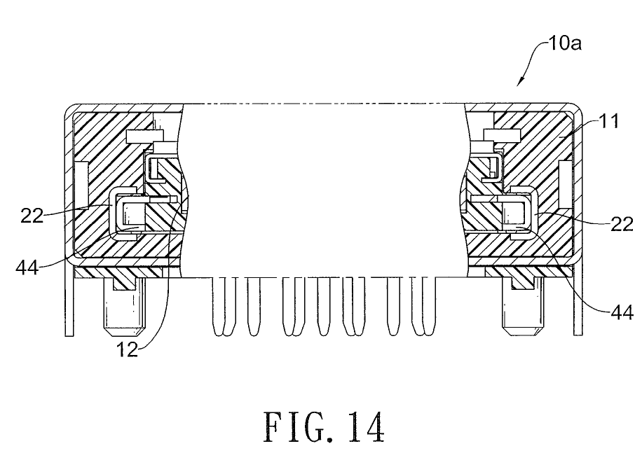

With reference to FIGS. 11, 12, and 13, the second embodiment may accommodate a two-in-one electrical connector 40a that also has an eSATA terminal set and a USB terminal set. The two-in-one electrical connector 40a comprises four USB first signal terminals 45 and seven eSATA signal terminals 43 respectively arranged at top and bottom inside the connecting base 41. The front electrical connection section of each eSATA signal terminal 43 is bent and flexible. Each of the USB first signal terminals 45 is flat. The two opposite outer sides of the base 41 are provided with two power terminals 44 with a U shaped cross sections. The size of each power terminal 44 is also larger than the USB first signal terminal 45 and the eSATA signal terminal 43. When the connector 40a is inserted into the socket 10a of the second embodiment, the connecting plate 12a separates the USB first signal terminals 45 and the eSATA signal terminals 43. The USB first signal terminals 45 are in touch with the USB terminals 31 on the first surface of the connecting plate 12a. The eSATA signal terminals 43 are in touch with the corresponding pins 21 of the eSATA terminal set 20 on the second surface of the connecting plate 12a. As the power terminals 44 are disposed on the two opposite outer sidewalls of the base 41, they are in touch with the power pins 22 on the two sidewalls of the open groove in the disclosed socket 10a. As shown in FIG. 14, the connector 40a can simultaneously obtain the 5 V DC power provided by the USB terminal set of the disclosed socket 10a, as set by the motherboard, but also the DC power smaller than 24 V provided by another set. The eSATA connector 40a thus conveniently obtains sufficient working power.

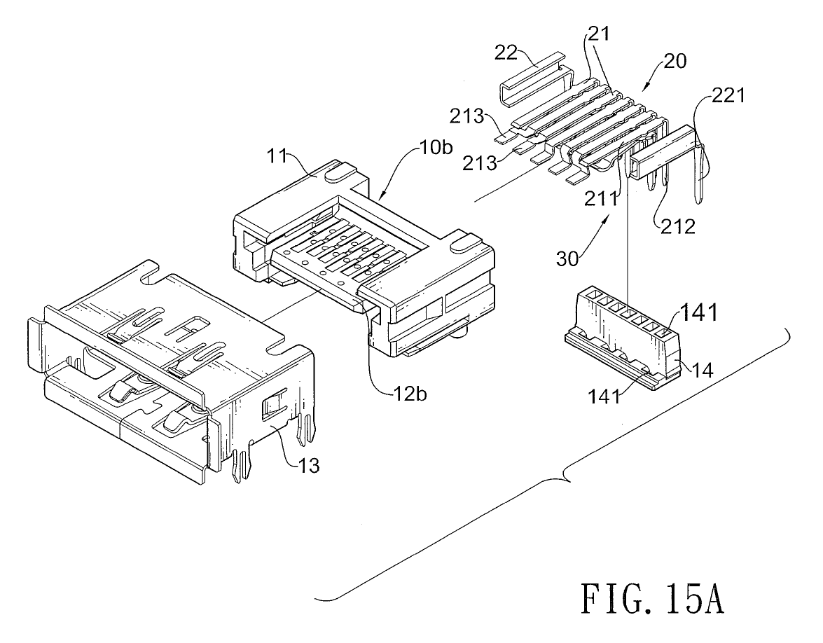

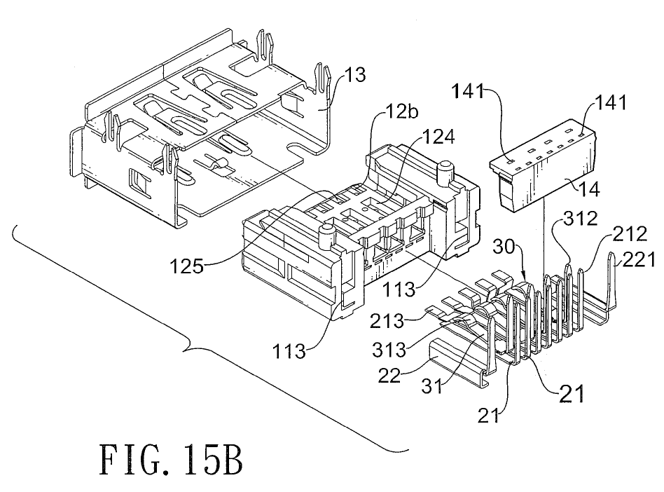

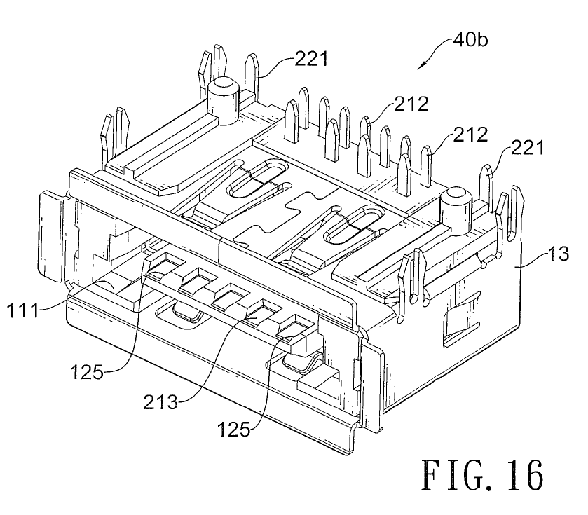

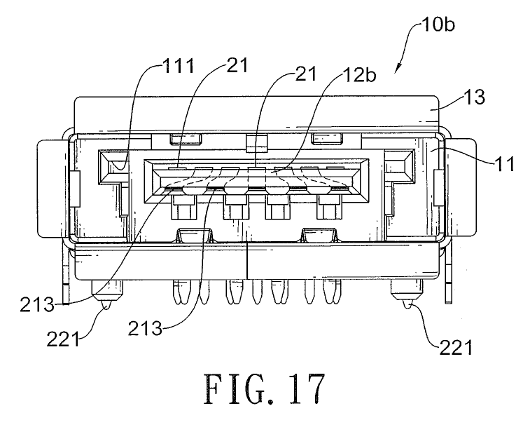

With reference to FIGS. 15A, 15B, 16, and 17, a third embodiment of the disclosed socket 10b shown in these drawings is basically the same as the first embodiment. However, the third embodiment uses two different USB protocol standards. One complies with the USB2.0 protocol standard, and the other with the USB3.0 protocol standard. Therefore, this embodiment is a three-in-one electrical connector.

In this embodiment, the second surface of the connecting plate 12b is formed with four parallel long grooves 124 from back to front and five parallel short grooves 125 from front to back. The short grooves 125 are not communicate with the long grooves 124, but communicate with the middle five parallel positioning grooves 121 of the first surface of the connecting plate 12b. Moreover, the central five pins 21 of the seven pins 21 of the eSATA terminal set 20 form forward a downward bending ladder part 213. When the seven pins 21 are disposed in the positioning grooves 121 on the first surface of the connecting plate 12b, the downward bending ladder parts 213 of the central five pins 121 go through the connecting plate 12b, exposing from the corresponding short grooves 125 on the second surface of the connecting plate 12b. The five downward bending ladder part 213 are used as the USB3.0 terminals. Therefore, they also can be used as five pins of the eSATA terminal set.

Furthermore, the USB2.0 terminal set in this embodiment includes four USB terminals 31. The front connection section of each of the USB terminals 31 is disposed in the corresponding long groove 124 on the second surface of the connecting plate 12b and is bent downward to form a bending part 313. The rear soldering section 312 of each of the USB terminals 31 goes through the back wall of the open groove 111 of the body 11 and then bends downwards. The rear soldering section 212 of each of the pins 21 in the eSATA terminal set goes through the back wall of the body and then bends downwards. To assemble the rear soldering sections 212, 312 of the pins of the eSATA terminal set and the terminals of the USB2.0 terminal set, respectively, this embodiment includes a terminal base 14 formed with eleven longitudinal through grooves 141. When the terminal base 14 is assembled to the rear part of the body 11 from bottom up, the eleven downward bending rear soldering sections 212, 312 go through the corresponding through grooves 141 and expose themselves downwards.

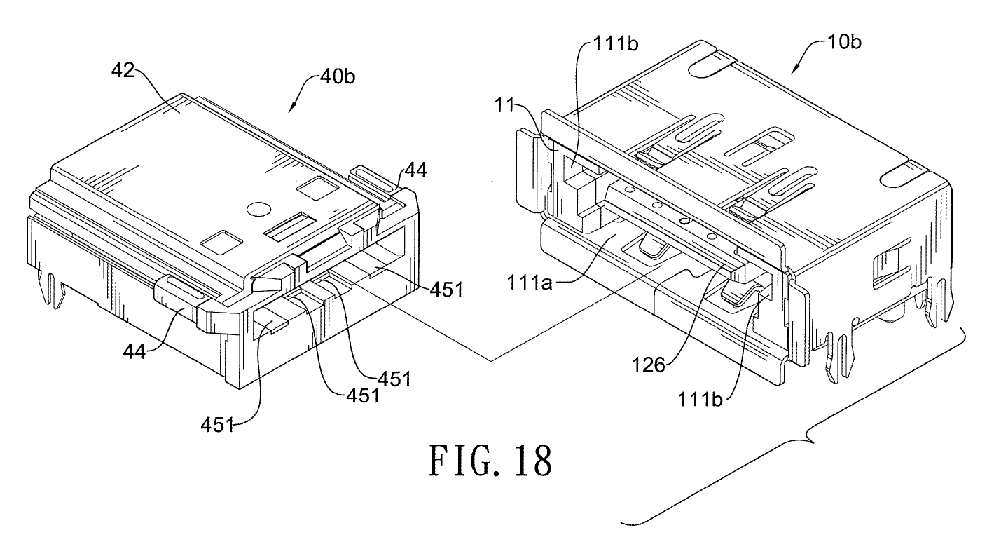

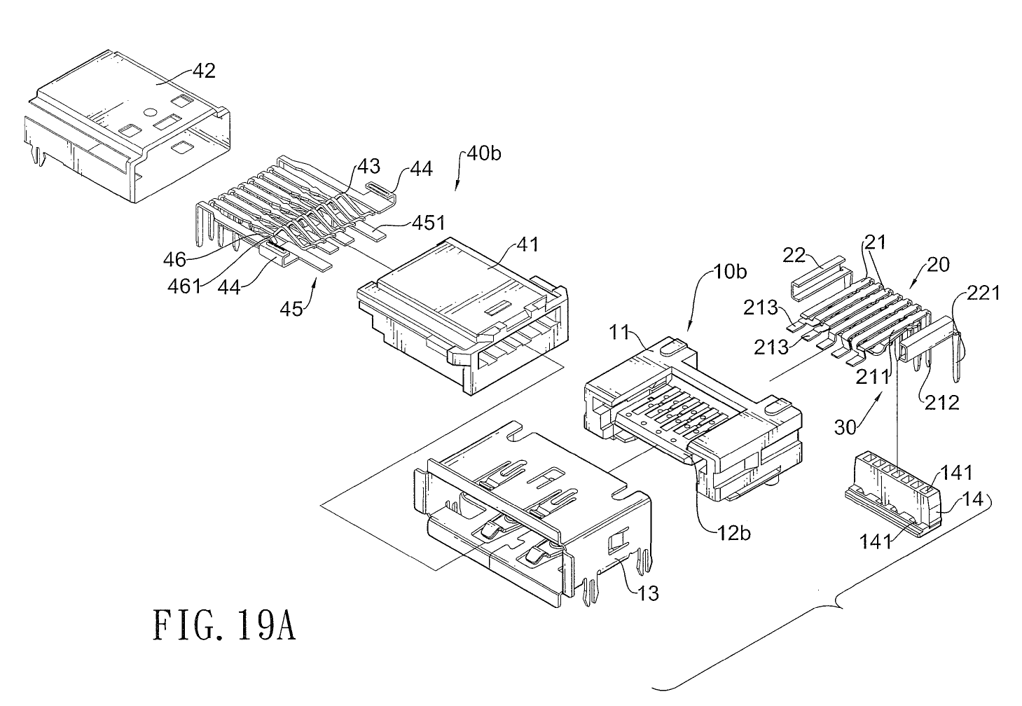

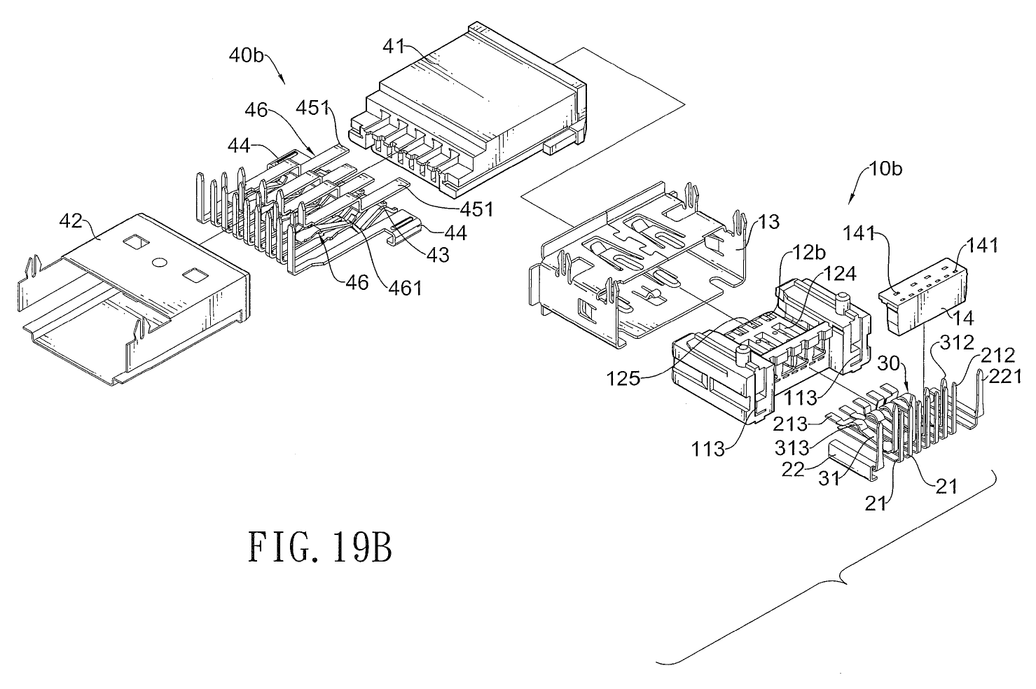

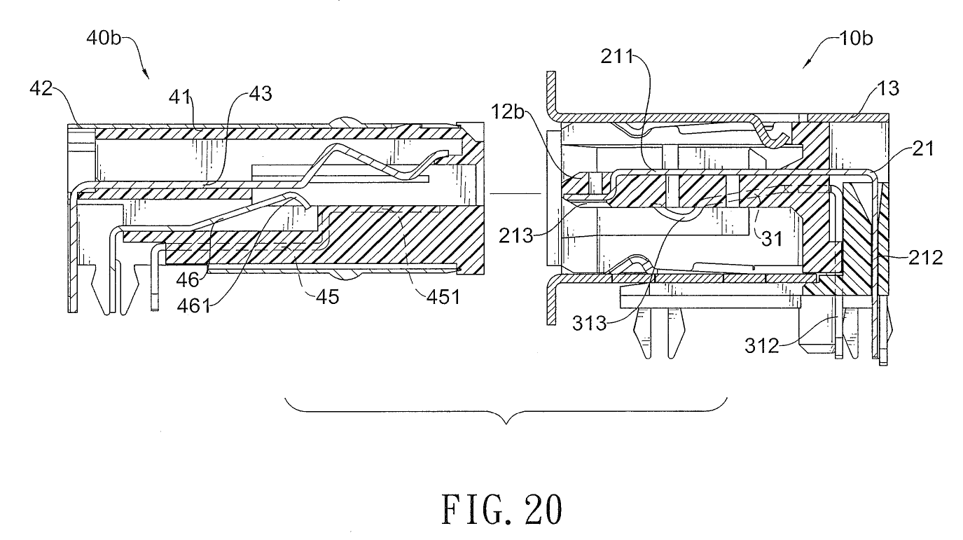

With reference to FIGS. 18, 19A, 19B, and 20, the third embodiment is used for the insertion of a three-in-one connector 40b that has an eSATA terminal set and two USB terminal set.

The interior of the base 41 of the connector 40B is disposed from top to bottom with seven eSATA signal terminals 43, five USB3.0 second signal terminals 46, and four USB2.0 first signal terminals 45. Each of the eSATA signal terminals 43 is bent. The front electrical connection section of each of the USB3.0 second signal terminals 46 is slant upwards, forming an upward bending part 461 at its front end. They are shorter than the eSATA signal terminals 43. The middle to front portion of the first signal terminal 45 of each of the USB2.0 first signal terminals 45 is formed upwards with an upper ladder part 451, corresponding to the height of the USB3.0 second signal terminals 46 but shorter than the USB3.0 second signal terminals 46. Moreover, on the two opposite outer sides of the base 41 at the height corresponding to the eSATA signal terminal 43, there are two power terminals 44 with a U-shaped cross section. The volume of each of the power terminals 44 is larger than that of each of the USB and eSATA signal terminals.

When such a connector 40b is inserted into the disclosed socket 10b of the third embodiment, the connecting plate 12b pushes the eSATA signal terminals 43 upwards, urging the USB3.0 and USB2.0 signal terminals downwards. They are thus correspondingly in touch with the five downward bending ladder parts 213 on the second surface of the connecting plate 12b and the four terminals 31 of the USB2.0 terminal set.

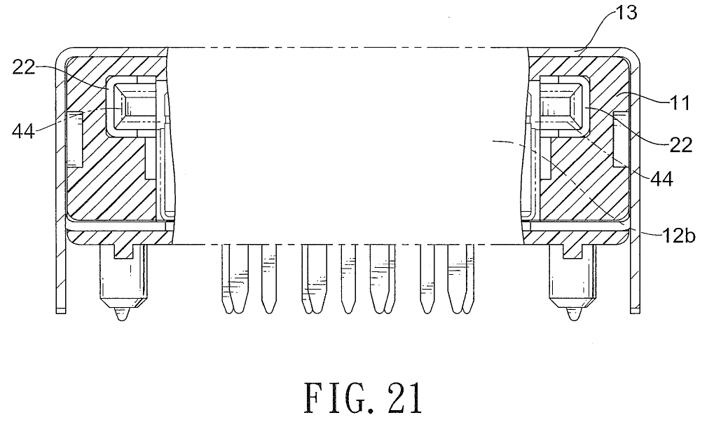

Since the power terminals 44 are disposed on the two opposite outer walls of the base 41, they are in contact with the power pins 22 on the two sidewalls of the open groove 111 of the disclosed socket 10b, as shown in FIG. 21. In addition to obtaining 5V DC power provided by the USB terminal set of the disclosed socket 10b according to the motherboard setting, the connector 40b can further obtain another set of DC power below 24 V, enabling the eSATA connector 40a to have a sufficient working voltage.

In summary, the invention is characterized in providing a power terminal set on the two opposite sidewalls of the body open groove, at a height corresponding to the eSATA terminal set. After an eSATA connector matching with this structure is inserted, the power terminal set directly supplies the working power of the eSATA connector. Not only does the invention save wires and cost for the connection with an external power supply, it is also very convenient in use.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. An external serial advanced technology attachment (eSATA) socket integrated with DC pins, comprising:
a body having
a front surface with an open groove defined inward of the body, the open groove having a rectangular chamber and two opposite recesses communicating with the rectangular chamber; and
a connecting plate protruding forward from a back wall of the rectangular chamber of the open groove at a height corresponding to the two opposite recesses;
an eSATA terminal set comprising a plurality of horizontally arranged pins whose front electrical connection sections are mounted in multiple positioning grooves on a first surface of the connecting plate and whose rear soldering sections go through the back wall of the open groove for soldering;
a power terminal set comprising two power pins mounted on two opposite recesses of the open groove at a height corresponding to the eSATA terminal set, each of the power pins having a rear end that penetrates backwards through the back wall of the open groove for soldering with an external power supply; and
a metal housing covering the body so that the open groove and the rear soldering sections of the eSATA terminal set are exposed.

2. The eSATA socket as claimed in claim 1 further comprising a USB terminal set that has a plurality of terminals disposed on a second surface of the connecting plate, opposite to the eSATA terminal set, wherein each USB terminal has a rear end that penetrates backwards through the back wall of the open groove for soldering.

3. The eSATA socket as claimed in claim 2, wherein front ends of a part of the pins of the eSATA terminal set penetrate through the second surface of the connecting plate and are formed respectively with a ladder part.

4. The eSATA socket as claimed in claim 1, wherein the eSATA terminal set is mounted on the first surface of the connecting plate.

5. The eSATA socket as claimed in claim 3, wherein the eSATA terminal set is mounted on the first surface of the connecting plate, the front ends of the middle five pins are formed with the ladder parts, respectively, the five ladder parts penetrate downward through the connecting plate and expose them at a front end of the second surface of the connecting plate, and the terminals of the USB terminal set are disposed on the first surface of the chip connecting plate.

6. The eSATA socket as claimed in claim 4, wherein two opposite sides of the body at the height corresponding to the eSATA terminal set of the connecting plate are formed respectively from back to front with a sliding groove in communication with the corresponding recess of the open groove for mounting the two power terminals.

7. The eSATA socket as claimed in claim 5, wherein two opposite sides of the body at the height corresponding to the eSATA terminal set of the connecting plate are formed respectively from back to front with a sliding groove in communication with the corresponding recess of the open groove for mounting the two power terminals.

8. The eSATA socket as claimed in claim 6, wherein each of the power terminals has a larger size than that of the pin of the eSATA terminal set.

9. The eSATA socket as claimed in claim 7, wherein each of the power terminals has a larger size than that of the pin of the eSATA terminal set.

10. The eSATA socket as claimed in claim 8, wherein each of the sliding grooves and the power terminals have a U shape cross section.

11. The eSATA socket as claimed in claim 9, wherein each of the sliding grooves and the power terminals have a U shape cross section.

12. The eSATA socket as claimed in claim 10, wherein the first surface of the connecting plate is further formed with a plurality of parallel positioning grooves for the corresponding pins of the eSATA terminal set to be mounted therein.

13. The eSATA socket as claimed in claim 11, wherein the first surface of the connecting plate is further formed with a plurality of parallel positioning grooves for the corresponding pins of the eSATA terminal set to be mounted therein.

14. The eSATA socket as claimed in claim 2, wherein a rear side of the body is further provided with a terminal base formed with a plurality of through grooves for the pins of the eSATA terminal set and the terminals of the USB terminal set to penetrate through.

15. The eSATA socket as claimed in claim 3, wherein a rear side of the body is further provided with a terminal base formed with a plurality of through grooves for the pins of the eSATA terminal set and the terminals of the USB terminal set to penetrate through.
